(19) United States
(12) Patent Application Publication
(10) Pub. No.: US 2008/0184845 A1
(43) Pub. Date: Aug. 7, 2008

(54) Planetary starter apparatus and assembly method thereof

(76) Inventors: Peter K. Farrar, Indianapolis, IN (US); Joel M. Gray, Fishers, IN (US); Wojciech M. Golab, Fishers, IN (US)

Correspondence Address: CANTOR COLBURN, LLP, 20 Church Street, 22nd Floor, Hartford, CT, 06103, US

(21) Appl. No.: 11/701,046

(22) Filed: Feb. 1, 2007

(51) Int. Cl. F02N 15/02; F16H 57/00; H02K 15/00

(52) U.S. Cl. 74/7 E; 29/732; 475/331; 475/345; 475/347

(57) ABSTRACT

A starter apparatus is disclosed. The starter apparatus includes a housing, a motor disposed within the housing, the motor having an armature shaft, and a planetary gear train disposed within the housing and in operable communication with the armature shaft. The planetary gear train includes a ring gear, a carrier shaft in operable communication with the planetary gear train for outputting a torque of the armature shaft transferred through the planetary gear train, and a dampener in exclusive connection between the ring gear and the housing.

### BACKGROUND OF THE INVENTION

The present disclosure relates generally to starters, and particularly to starter motors including a planetary gear train.

Present starters can utilize a planetary gear train to increase an amount of output torque and consequently reduce a speed of an output shaft of the starter. While starter motors of this type generally work well, they sometimes experience moderate torque oscillations that can accelerate wear of starter components including the planetary gear train.

Some starter motors include dampening mechanisms to absorb peaks of the moderate torque oscillations to alleviate impact on the affected components. These dampening mechanisms can help considerably but utilize design-specific components. That is to say that a particular dampening mechanism is configured for a particular starter housing and a planetary ring gear, for example. These may differ from such components used in otherwise similar starters without the dampening mechanisms. The dampening mechanisms often include a dampening material, and additional structural components, to incorporate the dampening material between the planetary ring gear and starter housing. Use of design-specific components can increase manufacturing complexity and cost, particularly in conjunction with a desire to provide a flexible product line of otherwise identical starter motors that either will or will not include the dampening mechanisms. Additionally, increasing the number of components within an assembly of a given size generally reduces manufacturing tolerances corresponding to each component within the assembly, thereby increasing manufacturing costs.

If an external size of the starter is desired to be held constant, volume consumed by the additional structural components within the starter housing may require a reduction in size of adjacent components of the planetary gear train. The reduction in size of the adjacent gear train components can result in reduced gear train component strength, reliability, operational life, and flexibility in choice of component materials.

Accordingly, there is a need in the art for a motor starter arrangement that overcomes these limitations.

### BRIEF DESCRIPTION OF THE INVENTION

An embodiment of the invention includes a starter apparatus having a housing, a motor disposed within the housing, the motor having an armature shaft, and a planetary gear train disposed within the housing and in operable communication with the armature shaft. The planetary gear train includes a ring gear, a carrier shaft in operable communication with the planetary gear train for outputting a torque of the armature shaft transferred through the planetary gear train, and a dampener in exclusive connection between the ring gear and the housing.

Another embodiment of the invention includes a method of assembling a starter including a planetary gear unit. The method includes disposing a ring gear of the planetary gear unit within a housing of the starter, determining if the starter is to include a dampener, and in response to determining that the starter is to comprise the dampener, disposing the dampener surrounding the ring gear.

These and other advantages and features will be more readily understood from the following detailed description of preferred embodiments of the invention that is provided in connection with the accompanying drawings.

### BRIEF DESCRIPTION OF THE DRAWINGS

Referring to the exemplary drawings wherein like elements are numbered alike in the accompanying Figures:

FIG. 1 depicts a starter motor in accordance with an embodiment of the invention;

FIG. 2 depicts a planetary ring gear in accordance with an embodiment of the invention;

FIG. 3 depicts a dampener in accordance with an embodiment of the invention;

FIG. 4 depicts an assembly of the planetary ring gear depicted in FIG. 2 with the dampener depicted in FIG. 3 in accordance with an embodiment of the invention;

FIG. 5 depicts a cross section of a starter including a dampener in accordance with an embodiment of the invention; [[and]]

FIG. 6 depicts a cross section of a starter including a fixed position planetary ring gear in accordance with an embodiment of the invention[[.]]; and

FIG. 7 depicts a flowchart of process steps for assembling a starter in accordance with an embodiment of the invention.

### DETAILED DESCRIPTION OF THE INVENTION

An embodiment of the invention provides a starter motor including a dampening mechanism to absorb peaks of torque oscillations. The dampening mechanism includes a single, direct interface between a planetary ring gear and a housing of the starter. In an embodiment, the planetary ring gear and the housing are common to starters that include dampening mechanisms as well as starters that include fixed position planetary ring gears. In an embodiment, the starter motor will include a planetary ring gear made from non-metallic materials.

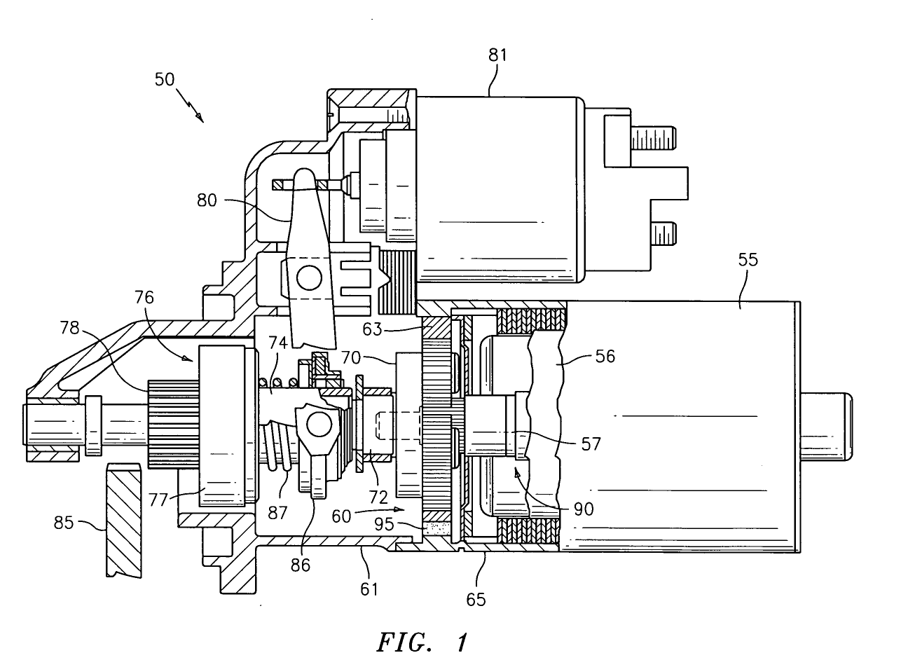

Referring now to FIG. 1, an embodiment of a starter motor 50, also herein referred to as a “starter”, with an integrated solenoid is depicted. The starter 50 includes an electric motor 55, which includes an armature 56 connected by an armature shaft 57 with a planetary gear unit 60. The planetary gear unit 60 is disposed within a gear housing 61. A ring gear 63 of the planetary gear unit 60 is retained within a housing 65 of the starter 50 and a planet gear carrier 70 is rigidly connected with a transmission gear shaft 72 of the planetary gear unit 60. The transmission gear shaft 72 is connected to a carrier shaft 74 of a free wheel clutch 76 having a hub 77. The hub 77 of the free wheel clutch 76 is connected rigidly with a starting gear 78. For starting an engine the starting gear 78 is advanced by a starter lever 80 driven by a starter solenoid 81 so that the starting gear 78 engages a flywheel 85 of the engine and rotates via the free wheel clutch 76 and the carrier shaft 74. The starter lever 80 engages with its lower end in a guide ring 86, which bears by a meshing spring 87 against a housing of the free wheel clutch 76. The entire assembly of rotating components from the starting gear 78 to the armature 56 of the electric motor 55 forms a starter drive train 90 with an inertial moment or inertia determined by a mass of the rotating components.

Because of different accelerations and different peripheral speeds during the starting process that may be related to a timing of different cycles of the engine, oscillations in resistive torque can result in shocks or impacts between the starting gear 78 and the armature 57. Depending upon the abruptness of these impacts and a maximum impact moment, these impacts can act mechanically to accelerate a wearing of the components within the starter 50.

In an embodiment, a dampener 95 to absorb some energy of the impacts is disposed in the drive train 90 between the starting gear 78 and the armature shaft 57 of the electric motor 55. The dampener 95 is made of a deformable and resilient material such as an elastomer. Such a material is capable of elastically deforming in response to an applied force and returning to an original form in response to a removal of the applied force. This deformation allows relative motion between the ring gear 63 and the housing 65. Examples of elastomers include natural rubber, butyl rubber, halogenated butyl rubbers, including, for example, chloro butyl rubber and bromo butyl bubber, polybutadiene, styrene-butadiene, nitrile rubber, hydrated nitrile rubbers, chloroprene rubber, ethylene propylene rubber, ethylene propylene diene rubber, epichlorohydrin rubber, polyacrylic rubber, silicone rubber, fluorosilicone rubber, fluoroelastomers, perfluoroelastomers, tetrafluoro ethylene/propylene rubbers, chlorosulfonated polyethylene, ethylene-vinyl acetate, thermoplastic elastomers, polyurethane rubber, and polysulfide rubber. The foregoing elastomer examples are intended for illustration, and not limitation.

It will be appreciated that an amount of deformation, in response to an application of force, is directly related to an amount of energy that is absorbed by the material of the dampener 95. Accordingly, the amount of energy that the dampener 95 is capable of absorbing is directly related to a selection of the dampener 95 material. In an embodiment, the dampener 95 is disposed between the ring gear 63 of the planetary gear unit 60 and the housing 65. In another embodiment, the dampener 95 is disposed between the ring gear 63 and the gear housing 61.

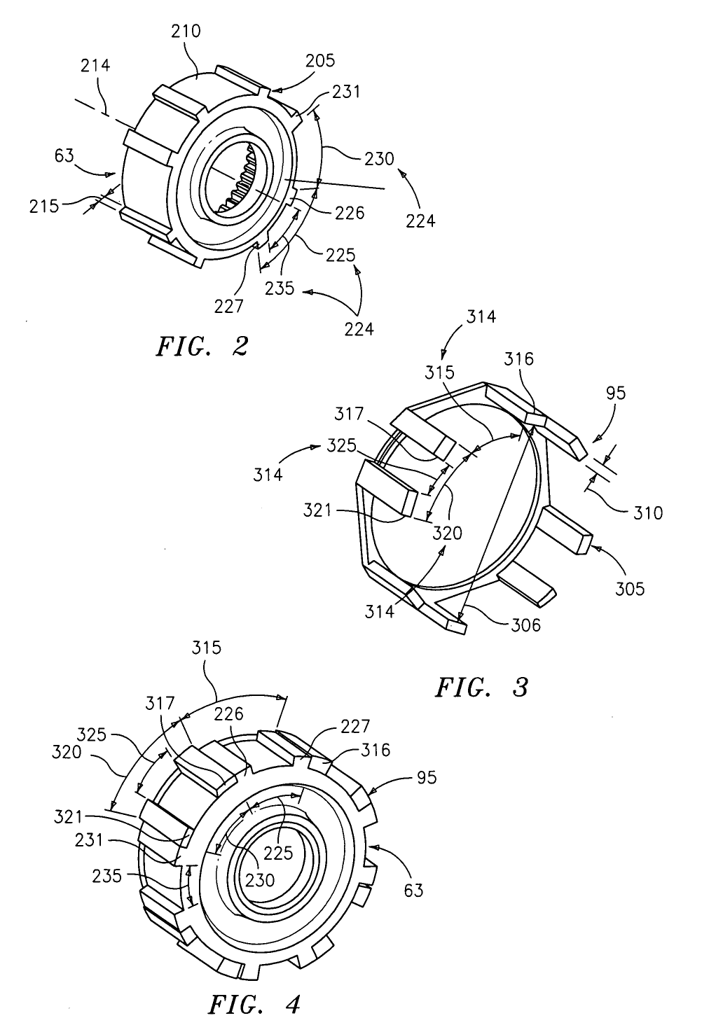

Referring now to FIG. 2, an embodiment of the ring gear 63 is depicted. The ring gear 63 includes a plurality of engagement features 205 disposed around a circumference of a body 210. The engagement features 205 extend radially outwardly from the body 210 of the ring gear 63. A center of the ring gear 63 is depicted by a center line 214. A radial dimension or radial distance 215 from the body 210 of the ring gear 63 to a portion of the engagement feature 205 having a greatest radial distance from the center of the ring gear 63 defines a height of the engagement feature 205. The engagement features 205 are distributed upon the body 210 of the ring gear including at least one circumferential spacing 224. In an embodiment, the circumferential spacing 224 includes at least one of a first circumferential spacing 225 including two engagement features 226, 227, a second circumferential spacing 230 between two engagement features 226, 231 and a third circumferential spacing 235 between two engagement features 226, 227.

Referring now to FIG. 3, another embodiment of the dampener 95 is depicted. The dampener 95 includes a plurality of contact features 305 disposed in a generally circular arrangement complementary to geometry of the body 210 of the ring gear 63. That is, the plurality of contact features 305 are configured for disposition surrounding the body 210 of the ring gear 63. Accordingly, the dampener 95 includes an inner diameter 306 that is approximately equal to an outer diameter of the body 210 of the ring gear 63. As used herein, the term “approximately” shall indicate a variation resulting from manufacturing tolerances and design intent to provide a desired amount of at least one of a clearance and a press fit. The plurality of contact features 305 are engagable with the ring gear 63 engagement features 205 and are configured for disposition adjacent the engagement features 205. As used herein, the term “adjacent”, with respect to disposition of features, shall refer to one feature disposed immediately next to another feature such that the two features are in physical contact, or include a minimum amount of clearance resulting from at least one of manufacturing and design tolerances.

The contact features 305 of the dampener 95 are distributed including at least one circumferential spacing 314. In an embodiment, the circumferential spacing 314 includes at least one of a first circumferential spacing 315 between two contact features 316, 317, a second circumferential spacing 320 including two contact features 317, 321, and a third circumferential spacing 325 between two contact features 317, 321.

Referring now to FIG. 4, the dampener 95 disposed surrounding the ring gear 63 is depicted. At least one circumferential spacing 224 of the ring gear 63 is approximately equal to at least one circumferential spacing 314 of the dampener 95. In an embodiment, the first circumferential spacing 225 including engagement features 226, 227 is approximately equal to the first circumferential spacing 315 between contact features 316, 317, thereby facilitating disposal of the engagement features 226, 227 between the contact features 316, 317. The second circumferential spacing 230 between two engagement features 226, 231 is approximately equal to the second circumferential spacing 320 including contact features 317, 321, thereby facilitating disposal of the contact features 317, 321 between the engagement features 226, 231. The third circumferential spacing 235 between the engagement features 226, 227 is approximately equal to the third circumferential spacing between the contact features 317, 321, thereby facilitating disposal of at least one external retention feature between at least one of the dampener 95 and the ring gear 63, as will be described further below.

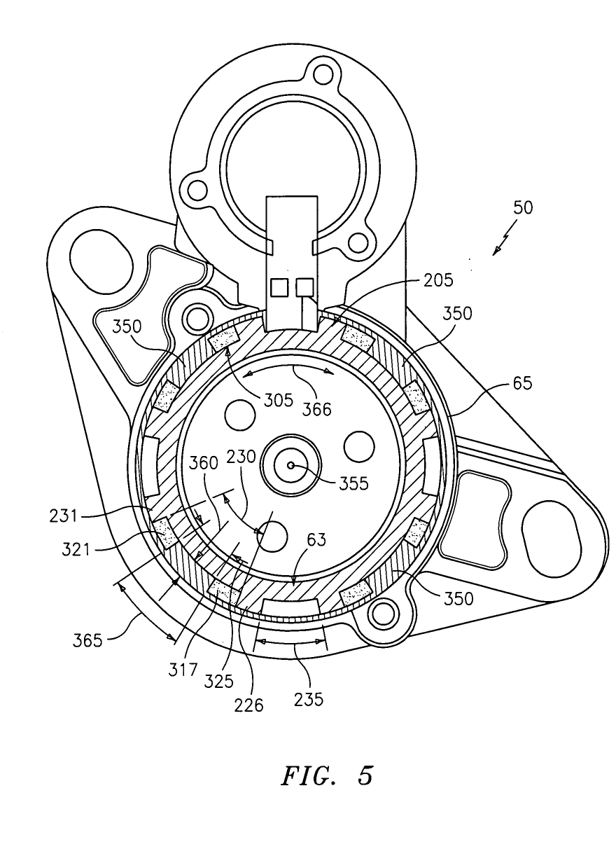

Referring now to FIG. 5, an end view of the starter 50 including the dampener 95 is depicted. The housing 65 includes a bore with an inner diameter dimensioned so as to facilitate disposing the ring gear 63 and the dampener 95 therein. At least one retention feature 350 extends radially inwardly toward a center 355 of the starter 50. A radial dimension 360 (also herein referred to as a “height”) of the retention feature 350 is defined as an amount of inward radial extension of the retention feature 350. In an embodiment, the height 360 of the retention feature 350 is approximately equal to the height 310 of the contact features 305 and the height of the engagement features 205. In an embodiment, the height 360 of each retention feature 350 is approximately equal to the height 310 of each engagement feature 205 and each contact feature 305. In an embodiment, a circumferential dimension 365, or width of the retention feature 350 is approximately equal to the third circumferential spacing 325 between two contact features 317, 321. At least one retention feature 350 is disposed adjacent at least one contact feature 305. In an embodiment, at least one retention feature 350 is disposed between two contact features 317, 321 including the third circumferential spacing 325, the two contact features 317, 321 disposed between two engagement features 226, 231.

Referring now to FIG. 1 in conjunction with FIG. 5, the housing 65 is fixedly attached via the gear housing 61 to the engine such that one reaction of torque produced by the motor 55 is transferred to the engine via the housing 65. Accordingly, another reaction of torque produced by the motor 55 is applied to the flywheel 85. Any oscillations in a resistive torque provided by the engine via the flywheel 85 will be reacted back through the starter drive train 90 to the housing 65. The oscillations in resistive torque will be reacted from the engagement features 205 of the ring gear 63 through the contact features 305 of the dampener 95 to the retention features 350 of the housing 65 in a circumferential direction, as indicated by direction line 366. In response to an oscillation in resistive torque, the contact features 305 will deform, allowing circumferential rotation of the ring gear 63 relative to the housing 65, thereby absorbing at least a portion of energy resulting from the oscillation in resistive torque, as described above.

The dampener 95 is in direct, or exclusive connection between the ring gear 63 and the housing 65. As used herein, the term “exclusive connection” describes a connection wherein no components (such as components used to arrange or support dampening material, for example) in addition to the dampener 95 are utilized to transfer torque between the ring gear 63 and the housing 65. Accordingly, a transfer of torque between the engagement features 205 and the retention features 350 via the contact features 305 is said to be direct.

The direct transfer of torque via the contact features 305 reduces a total number of components within the starter 50 as compared to present starters having dampeners that use additional components to incorporate dampening material into the starter. It will be appreciated that a reduction in a number of components within a given space will generally allow increasing dimensional tolerances associated with each component within the space. The increase in dimensional tolerances associated with each component is contemplated to result in a reduced manufacturing cost of each of the components. Furthermore, it will be appreciated that a reduction in a number of components within a given assembly will generally result in an increase in overall assembly reliability.

It will be appreciated that use of any additional component within the housing 65 of a given size, to transfer torque between the engagement features 205 and the retention features 350, can result in a reduction of size of at least one the engagement features 205, the contact features 305, and the retention features 350 to accommodate use of the additional component. A reduction in size of the features 205, 305, 350, for a given material, will generally result in a decrease in strength of at least one of the features 205, 305, 350. Accordingly, the direct transfer of torque described above allows for maximum size, and corresponding strength, of the features 205, 305, 350. It is contemplated that the increase of strength provided by the direct transfer of torque is sufficient to incorporate, within an embodiment, ring gears 63 made of non-metallic materials. While an embodiment has been described having a ring gear 63 made of a non-metallic material, it will be appreciated that the scope of the invention is not so limited, and that the invention will also apply to starter motors 50 having ring gears 63 made of other materials, such as metallic materials, for example.

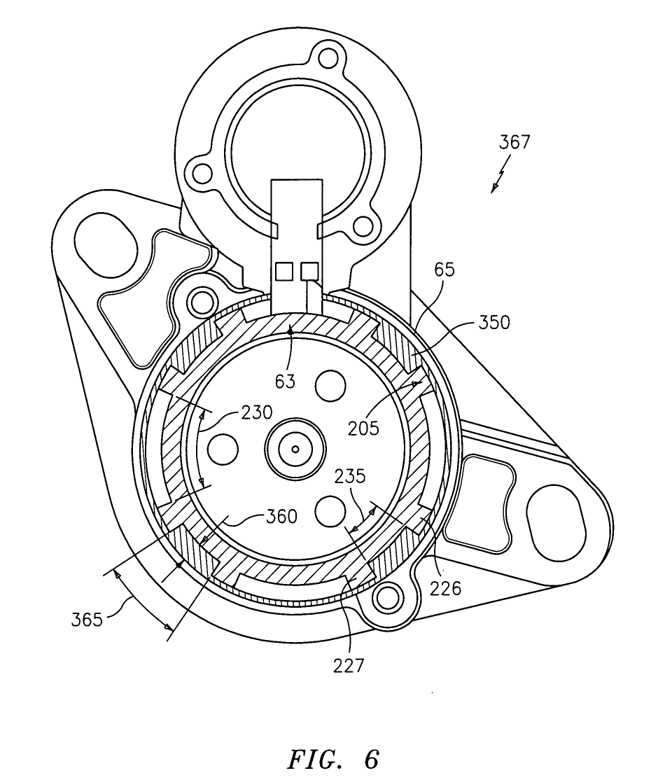

Referring now to FIG. 6, an embodiment of a starter 367 including the ring gear 63 fixed in position (excluding the dampener 95) is depicted. The housing 65 of the starter 50 including the dampener 95 is the same housing 65 of the starter 367 including the ring gear 63 fixed in position. Accordingly, the retention features 350 are the same, including the height 360 and width 365. Further, the starter 367 utilizes the same ring gear 63 as the starter 50 including the dampener 95. In an embodiment, the width 365 of the retention feature 350 is approximately equal to the third circumferential spacing 235 of the ring gear 63. Accordingly, the ring gear 63 is disposed within the housing 65 such that at least one retention feature 350 is disposed between two engagement features 205 including the third circumferential spacing 235.

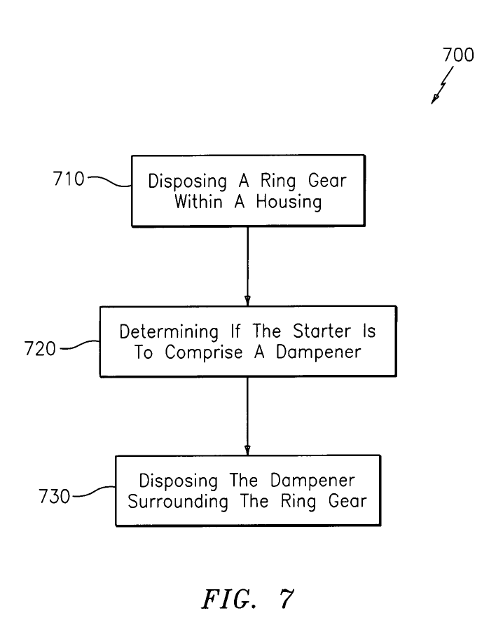

In view of the foregoing, the ring gear 63 and dampener 95 facilitate a method of assembly of a starter, such as the starter 50, 367 including the planetary gear unit 60. An embodiment of the method includes assembling the starter 50 including the dampener 95 and the starter 367 including the ring gear 63 fixed in position utilizing the same housing 65 and ring gear 63. Referring now to FIG. 7 in conjunction with FIG. 5 and FIG. 6, a flowchart 700 of process steps for assembling the starter 50, 367 is depicted.

The method includes disposing at Step 710 the ring gear 63 of the planetary gear unit 60 within the housing 65 of the starter 50, 367, determining at Step 720 if the starter 50, 367 is the starter 50 including the dampener 95 or the starter 367 including the ring gear 63 fixed in position. In response the determination at Step 720 that the starter 50 will include the dampener 95, the method further includes disposing at Step 730 the dampener 95 surrounding the ring gear 63.

In an embodiment in which the starter 367 includes the ring gear 63 fixed in position, the disposing at Step 710 the ring gear 63 includes orienting the ring gear 63 that the retention feature 350 of the housing 65 is disposed adjacent to at least one of the plurality of engagement features 205. In an embodiment, orienting the ring gear 63 includes disposing two engagement features 205, such as the engagement features 226, 227 adjacent the retention feature 350 disposed therebetween.

In an embodiment in which the starter 50 includes the dampener 95, 20, the disposing the dampener 95 at Step 730 includes orienting the dampener 95 including the plurality of contact features 305 such that at least one contact feature 305 is adjacent at least one of the plurality of engagement features 205 of the ring gear 63. In an embodiment, the ring gear 63 is oriented such that the retention feature 350 is disposed adjacent at least one contact feature 205, the at least one contact feature 205 being disposed adjacent at least one engagement feature 305. In an embodiment, the ring gear 63 is oriented such that the retention feature 350 is disposed between two contact features 317, 321, the contact features 317, 321 disposed between two engagement features 226, 231.

As disclosed, some embodiments of the invention may include some of the following advantages: an ability to increase a strength of a torque dampened starter planetary ring gear within a given dimensional envelope; an ability to reduce manufacturing tolerance requirements for components within a torque dampened starter by reducing the total number of parts; an ability to increase a reliability of a torque dampened starter by reducing the total number of parts; an ability to incorporate a non-metallic planetary ring gear within a torque dampened starter; an ability to reduce manufacturing cost and complexity by utilizing a common housing and planetary ring gear for torque dampened starters and starters utilizing planetary ring gears fixed in position.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A starter apparatus comprising:
a housing;
a motor disposed within the housing, the motor having an armature shaft;
a planetary gear train disposed within the housing and in operable communication with the armature shaft, the planetary gear train comprising a ring gear;
a carrier shaft in operable communication with the planetary gear train for outputting a torque of the armature shaft transferred through the planetary gear train; and
a dampener in exclusive connection between the ring gear and the housing.

2. The starter apparatus of claim 1, wherein:
the dampener is made of deformable and resilient material.

3. The starter apparatus of claim 2, wherein:
the dampener is made of an elastomer.

4. The starter of claim 1, wherein:
the ring gear is non-metallic.

5. The starter apparatus of claim 1, wherein:
the ring gear comprises a plurality of engagement features extending radially outwardly; and
the dampener comprises a plurality of contact features engagable with the ring gear engagement features.

6. The starter apparatus of claim 5, wherein:
at least one of the plurality of engagement features is disposed adjacent at least one of the plurality of contact features.

7. The starter apparatus of claim 6, wherein:
at least two of the plurality of engagement features are disposed between two of the plurality of contact features.

8. The starter apparatus of claim 6, wherein:
at least two of the plurality of contact features are disposed between two of the plurality of engagement features.

9. The starter apparatus of claim 5, wherein:
a radial dimension of at least one of the plurality of engagement features is approximately equal to a radial dimension of at least one of the contact features.

10. The starter apparatus of claim 5, wherein:
a radial dimension of each of the plurality of engagement features is approximately equal to a radial dimension of each of the contact features.

11. The starter apparatus of claim 5, wherein:
at least one circumferential spacing between two of the plurality of engagement features is approximately equal to at least one circumferential spacing between two of the plurality of contact features.

12. The starter apparatus of claim 5, wherein:
the housing comprises a bore and a plurality of retention features extending inwardly toward a center of the bore.

13. The starter apparatus of claim 12, wherein:
a radial dimension of at least one of the retention features is approximately equal to a radial dimension of at least one of the engagement features; and
a radial dimension of at least one of the retention features is approximately equal to a radial dimension of at least one of the contact features.

14. The starter apparatus of claim 13, wherein:
the radial dimension of each of the retention features is approximately equal to the radial dimension of each of the engagement features; and
the radial dimension of each of the retention features is approximately equal to the radial dimension of each of the contact features.

15. The starter apparatus of claim 12, wherein:
a circumferential dimension of at least one of the retention features is approximately equal to a circumferential spacing between two of the plurality of contact features.

16. The starter apparatus of claim 12, wherein:
a circumferential dimension of at least one of the retention features is approximately equal to a circumferential spacing between two of the plurality of engagement features.

17. A method of assembling a starter including a planetary gear unit, the method comprising:
disposing a ring gear of the planetary gear unit within a housing of the starter;
determining if the starter is to comprise a dampener; and
in response to determining that the starter is to comprise the dampener, disposing the dampener surrounding the ring gear.

18. The method of claim 17, wherein the disposing the ring gear comprises:
orienting the ring gear comprising a plurality of engagement features such that a retention feature of the housing is disposed adjacent at least one of the plurality of engagement features.

19. The method of claim 18, wherein the orienting comprises:
orienting the ring gear such that two of the plurality of engagement features are disposed adjacent the retention feature.

20. The method of claim 17, wherein the disposing the dampener comprises:
orienting the dampener comprising a plurality of contact features such that at least one contact feature is adjacent at least one of a plurality of engagement features of the ring gear.

21. The method of claim 20, wherein the disposing the ring gear comprises:
orienting the ring gear such that a retention feature of the housing is disposed between at least one engagement feature and at least one contact feature.

22. The method of claim 21, wherein the disposing the ring gear comprises:
orientating the ring gear such that the retention feature is disposed between two contact features, the contact features disposed between two engagement features.
